(19) United States
(12) Patent Application Publication
(10) Pub. No.: US 2007/0056695 A1
(43) Pub. Date: Mar. 15, 2007

(54) Perforated metal shutters

(76) Inventor: Marc A. Chang, Miami, FL (US)

Correspondence Address: LITMAN LAW OFFICES, LTD, PO BOX 15035, CRYSTAL CITY STATION, ARLINGTON, VA, 22215, US

(21) Appl. No.: 11/221,870

(22) Filed: Sep. 9, 2005

(51) Int. Cl. E05D 15/26

(52) U.S. Cl. 160/206

(57) ABSTRACT

A shutter assembly for protecting windows from damage especially during severe weather. The shutters are of the folding accordion style having hinged panels. Each panel includes front and rear spaced-apart sheets. Reinforcing structure is sandwiched between the front and rear sheets. The sheets and reinforcing structure are fabricated from perforated metal. The perforations are positioned to create a staggered effect such that a tortuous flow pattern is formed to minimize the force of airflow therethrough. The perforated metal barrier protects the windows from wind-blown debris. The perforations also function to allow light to enter so that the feelings of isolation and claustrophobia are abated.

### BACKGROUND OF THE INVENTION

1. Field of the Invention

The present invention generally relates to protective apparatus. More specifically, the present invention is drawn to shutter apparatus for protecting windows during severe storms.

2. Description of the Related Art

Severe weather including tropical storms, hurricanes, tornados, etc., causes millions of dollars of damage annually. A great part of the damage is due to wind and wind-blown debris shattering windows and permitting the rain to enter the structure, thus causing severe water damage. During hurricane season, it is common to see home and business owners erecting plywood barriers to protect the windows from the onslaught of the approaching storm. The above scenario requires that the owners rush to the lumberyard, purchase the plywood sheets, transport the sheets from the lumberyard to the home or business and install the sheets over the windows to be protected. When the storm has passed, the plywood sheets must be dismantled and discarded. This endeavor involves a great deal of time and expense, not to mention nerve-wracking tension. It would most certainly be less stressful, convenient and economic if an efficient durable system were available to accomplish the protective function simply by closing shutters.

The related art is awash with shutter apparatus designed to protect windows from damage during severe weather. Pertinent samples of such related art are cited and identified in the accompanying IDS document. However, none of the cited and identified inventions and patents, taken either singly or in combination, is seen to disclose a shutter system constructed of perforated metal having staggered holes as will be subsequently described and claimed in the instant invention.

### SUMMARY OF THE INVENTION

The present invention is drawn to shutters for protecting windows from damage during severe weather. The shutters are of the folding accordion style having hinged panels. Each panel includes front and rear spaced-apart faces. Reinforcing structure is sandwiched between the front and rear faces. The faces and reinforcing structure are fabricated from perforated metal having a staggered hole design. The perforations are positioned to create the staggered effect such that a crisscross flow pattern is formed to minimize the force of airflow therethrough. The perforated metal barrier protects the windows from wind-blown debris. The perforations allow light to enter so that the feelings of isolation and claustrophobia are abated.

Accordingly, the invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a perforated metal shutter assembly according to the present invention.

FIG. 2 is a front, perspective view of a perforated metal shutter assembly according to the present invention.

FIG. 3 is a partial, exploded, perspective view of the perforated panels a perforated metal shutter assembly according to the present invention.

FIG. 4 is a partial, top, cut-away view of a perforated metal shutter assembly according to the present invention.

FIG. 5 is a partial, side, cut-away view of a perforated metal shutter assembly according to the present invention.

Similar reference characters denote corresponding features consistently throughout the attached drawings.

### DETAILED DESCRIPTION OF THE PREFERRED EMBODIMENTS

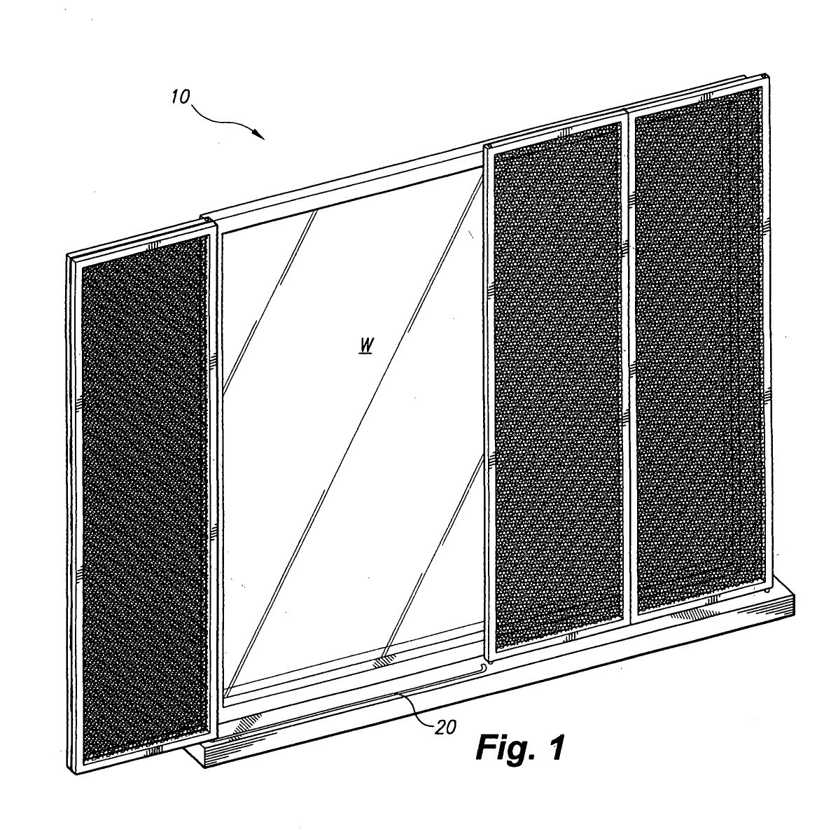

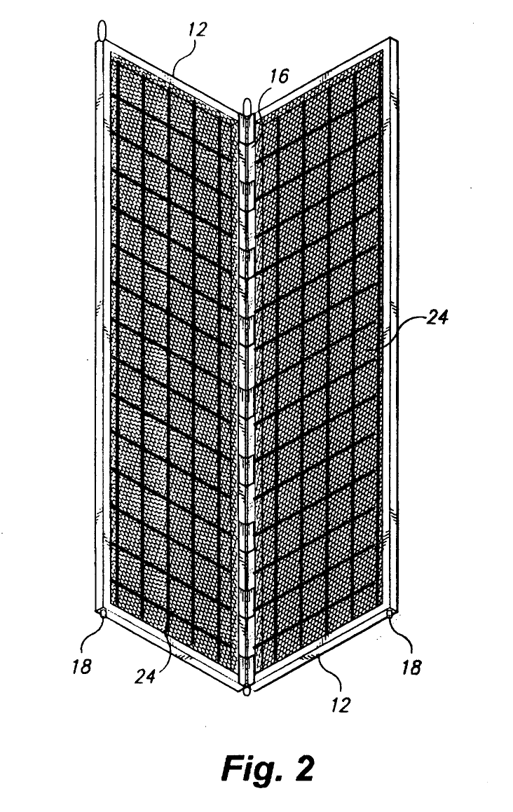

Attention is first directed to FIGS. 1 and 2 wherein the protective shutter assembly of the present invention is generally indicated at 10. The assembly is mounted adjacent window W and, when closed, will function to protect the window from the damaging effects of a severe storm. As stated above, the assembly is of the conventional accordion type and comprises at least two identical panels. Each panel comprises a frame 12, which frame defines the perimeter of the panel. Hinges 16 are provided at an edge of each frame to connect the frames in folding abutment. Spring loaded slide rods 18 are disposed at the outer corners of each frame to allow the frame to be guided in slide tracks 20 (only one shown) formed in the windowsill.

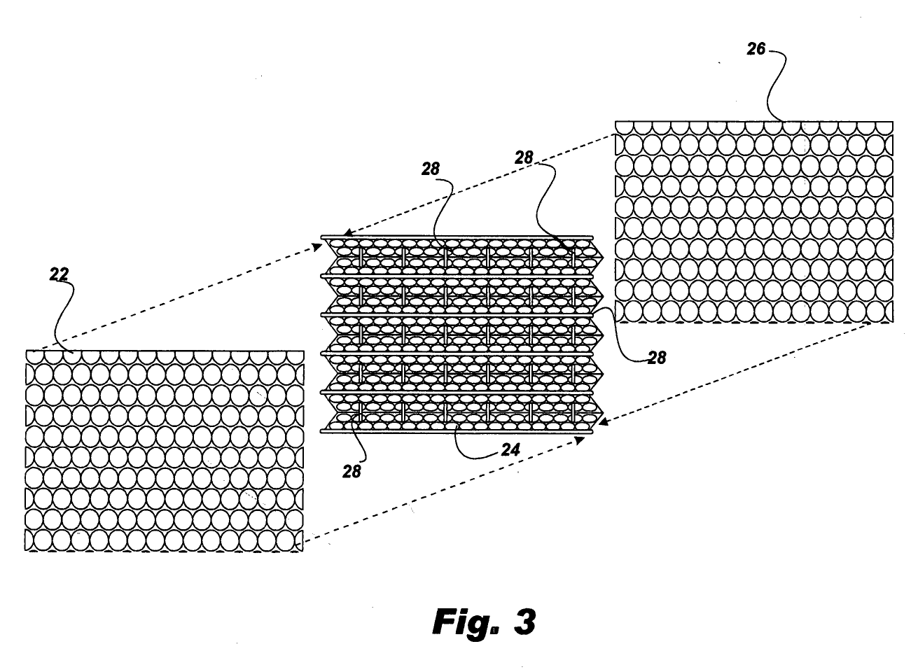

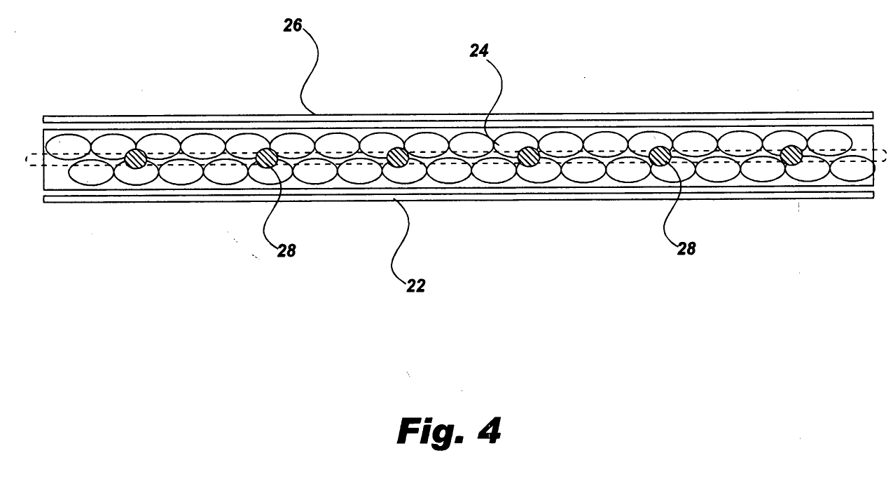

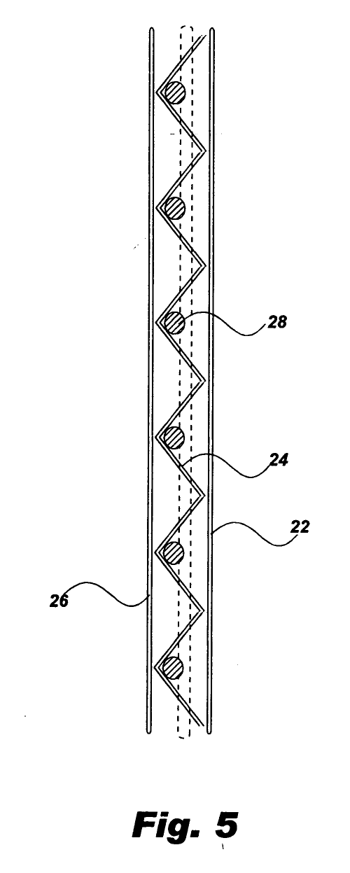

As best seen in FIGS. 3-5, each frame encloses a barrier, which barrier comprises spaced sheets defining a front sheet 22 and a rear sheet 26 both fabricated of perforated metal. A corrugated sheet 24, also fabricated of perforated metal, is sandwiched between front sheet 22 and rear sheet 26. Construction is such that the perforations of the sheets are uniformly staggered to form a tortuous path for the flow of air therethrough. Vertical and horizontal rods 28 provide support to rigidify the barrier. The perforations are approximately ⅛ of an inch in diameter.

It is to be understood that the present invention is not limited to the embodiments described above, but encompasses any and all embodiments within the scope of the following claims.

I claim:

1. A shutter for covering a window and preventing damage to the window during severe weather, said shutter comprising:
a frame defining the perimeter of the shutter;
a barrier enclosed within said frame, said barrier having a front sheet and a rear sheet spaced from said front sheet;
a reinforcing member sandwiched between said front sheet and said rear sheet, wherein said front sheet, said rear sheet and said reinforcing member are fabricated from perforated metal.

2. The shutter for covering a window and preventing damage to the window during severe weather according to claim 1, wherein perforations in said front sheet are uniformly staggered relative to the perforations in said rear sheet.

3. The shutter for covering a window and preventing damage to the window during severe weather according to claim 1, wherein said reinforcing member is a sheet of perforated corrugated metal.

4. The shutter for covering a window and preventing damage to the window during severe weather according to claim 1, wherein said reinforcing member is sheet of perforated corrugated metal having vertically positioned reinforcing rods positioned therein.

5. The shutter for covering a window and preventing damage to the window during severe weather according to claim 1, wherein said reinforcing member is sheet of perforated corrugated metal having horizontally positioned reinforcing rods positioned therein.

6. The shutter for covering a window and preventing damage to the window during severe weather according to claim 1, wherein perforations in said reinforcing member are uniformly staggered relative to perforations in said front sheet and said rear sheet.

7. A shutter assembly for covering a window and preventing damage to the window during severe weather, said shutter assembly comprising:
at least two frame members mounted adjacent said window, each respective frame member defining a perimeter;
a respective barrier enclosed within each frame member, each respective barrier having a front sheet and a rear sheet spaced from said front sheet;
a respective reinforcing member sandwiched between each said front sheet and each said rear sheet, wherein each front sheet, each rear sheet and each reinforcing member are fabricated from perforated metal; and
a structure for pivotally connecting said at least two frame members.

8. The shutter assembly for covering a window and preventing damage to the window during severe weather according to claim 7, wherein said structure for pivotally connecting is a hinge.

9. The shutter assembly for covering a window and preventing damage to the window during severe weather according to claim 7, wherein perforations in each respective front sheet are uniformly staggered relative to the perforations in each respective rear sheet.

10. The shutter assembly for covering a window and preventing damage to the window during severe weather according to claim 7, wherein each said reinforcing member is a sheet of perforated corrugated metal.

11. The shutter assembly for covering a window and preventing damage to the window during severe weather according to claim 7, wherein each said reinforcing member is sheet of perforated corrugated metal having vertically and horizontally positioned reinforcing rods positioned therein.

12. The shutter for covering a window and preventing damage to the window during severe weather according to claim 7, wherein perforations in each said reinforcing member are uniformly staggered relative to perforations in each said front sheet and each said rear sheet.

13. A shutter assembly for covering a window and preventing damage to the window during severe weather, said shutter assembly comprising:
at least two frame members mounted adjacent said window, each respective frame member defining a perimeter;
a respective barrier enclosed within each frame member, each respective barrier having a front sheet and a rear sheet spaced from said front sheet;
a respective reinforcing member sandwiched between each said front sheet and each said rear sheet, wherein each front sheet, each rear sheet and each reinforcing member are fabricated from perforated metal, wherein perforations in each respective front sheet are uniformly staggered relative to perforations in each respective rear sheet; and
a hinge member for pivotally connecting said at least two frame members.

14. The shutter assembly for covering a window and preventing damage to the window during severe weather according to claim 13, wherein each said reinforcing member is sheet of perforated corrugated metal having vertically and horizontally positioned reinforcing rods positioned therein.

15. The shutter for covering a window and preventing damage to the window during severe weather according to claim 13, wherein perforations in each said reinforcing member are uniformly staggered relative to perforations in each said front sheet and each said rear sheet.
